(19) United States
(12) Patent Application Publication
(10) Pub. No.: US 2007/0101370 A1
(43) Pub. Date: May 3, 2007

(54) Television program selection

(75) Inventor: Richard C. Calderwood, Portland, OR (US)

Correspondence Address: RICHARD CALDERWOOD;STEXAR CORP., 20400 NW AMBERWOOD DR. #100, BEAVERTON, OR, 97006-7009, US

(73) Assignee: Stexar Corp.

(21) Appl. No.: 11/261,828

(22) Filed: Oct. 28, 2005

(51) Int. Cl. H04N 5/445; G06F 3/00; H04N 7/20; G06F 13/00

(52) U.S. Cl. 725/47; 725/38; 725/63; 725/68; 725/39

(57) ABSTRACT

A television set, set-top box, or the like, which finds a corresponding HD program when a user selects an SD program for viewing or recording, and which gives the user a visual prompt enabling him to select the HD program instead. The HD channel is inserted into the same on-screen programming guide page as the SD channel, regardless of their channel numbers.

### BACKGROUND OF THE INVENTION

1. Technical Field of the Invention

This invention relates generally to watching or recording television programs, and more specifically to programs broadcast in both standard definition (SD) and high definition (HD).

2. Background Art

FIG. 1 illustrates a conventional television set, consisting basically of a display panel (illustrated as showing a scene from a girls soccer game) and a set of electronics. The electronics include a panel driver for providing video signals to the display panel, a tuner for extracting video content from a user-selectable channel, a host of input and output connectors and their associated circuitry, a variety of user-operable buttons for controlling operation of the television set, a wireless receiver for receiving signals from a remote control unit (not shown) which includes additional user-operable buttons, logic such as a microprocessor or a digital signal processor or an ASIC for performing control logic operations of the television set, and memory for storing a variety of data. The data may include, for example, an electronic programming guide (EPG) which identifies which programs are available on which channels at which times. The data may further include a menu control program, via which the user controls which programs are selected for viewing and/or recording.

Various television channels broadcast at various resolution levels. Some channels are SD, and others are HD. Some programs are simultaneously broadcast in both SD and HD, on different channels.

When a user pulls up the on-screen programming guide, the EPG data are typically displayed as a matrix, in which each row includes information for programs on a given channel, and each column includes information for programs during a given half-hour time slot. The data for the respective channels are sorted in ascending numerical order. Unfortunately, in virtually all instances, cable and satellite television system operators group the HD channels into a range of channel numbers, such as 700-799. This means that when a user pulls up the on-screen programming guide, the SD and HD channels of a simulcast are typically many, many pages (or screens) removed from each other, and the user has to page repeatedly to get from one to the other.

What is needed is an improved and more intelligent television set which provides a more user-friendly and easily-used on-screen programming guide.

### BRIEF DESCRIPTION OF THE DRAWINGS

FIG. 1 shows a television set according to the prior art.

FIGS. 2 and 3 show a television set displaying an on-screen programming guide according to one embodiment of this invention.

FIG. 4 shows the television set of FIG. 3 further displaying a simulcast selection dialog box as part of the on-screen programming guide methodology, according to one embodiment of this invention.

FIG. 5 shows one method of operation of the television set of FIG. 3, illustrating its display of the on-screen programming guide.

FIG. 6 shows one method of operation of the television set of FIG. 3, illustrating in greater detail its identification of a simulcast and its display of the on-screen programming guide.

FIG. 7 shows one embodiment of the invention in which the on-screen programming guide display apparatus is implemented as a set-top box or receiver which is separate from the television display panel device.

FIG. 8 shows another embodiment in which the television itself is the on-screen programming guide display apparatus.

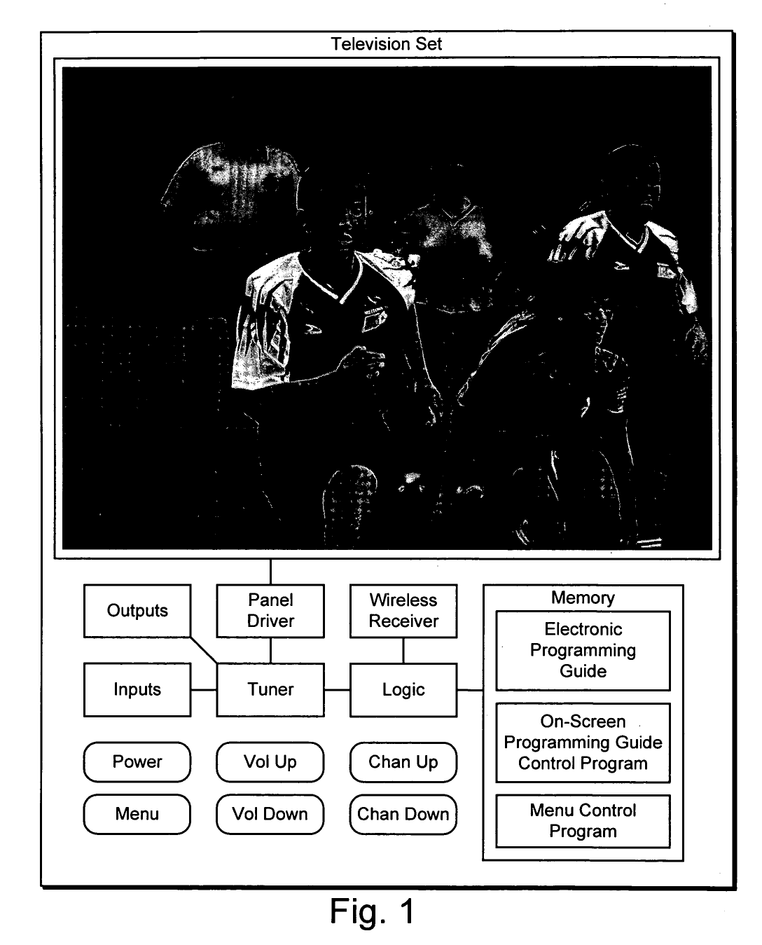

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

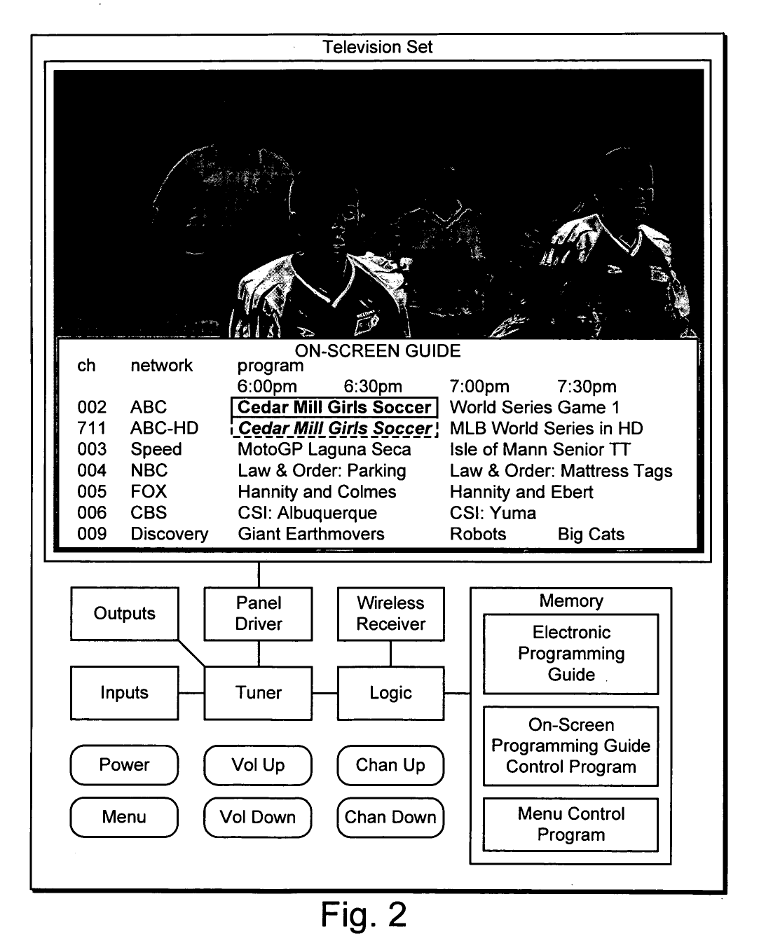

FIG. 2 illustrates a television set according to one embodiment of this invention, shown as displaying a scene from a girls soccer game, and further showing an on-screen programming guide displayed according to one embodiment of the method of this invention.

The on-screen programming guide displays program information for a variety of programs on a variety of channels. The soccer game being viewed is the “Cedar Mill Girls Soccer” program (highlighted by a solid-line outline box and bold text) on channel 002 “ABC” from 6:00 pm to 7:00 pm. The next sequentially numbered channels which are available are channel 003, 004, 005, 006, and 009, on this particular cable system, and the on-screen programming guide displays the program information for programs available on those channels.

The on-screen programming guide control software (or hardware) of the television set has identified that the currently viewed channel 002 is an SD channel and has a corresponding HD channel 711 “ABC-HD”. The software has inserted this HD channel's program information into the on-screen programming guide (highlighted by a dashed-line outline box and bold text), even though, numerically, it would normally be found many, many pages lower in the on-screen programming guide. In one embodiment, the software inserts it immediately after the corresponding SD channel's information.

In one embodiment, only the HD program information for the currently viewed channel is thus inserted into the on-screen programming guide. In another embodiment, all HD program information is inserted, for all SD channels which have HD counterparts, limited only by the number of lines of information that can be displayed in the on-screen programming guide window.

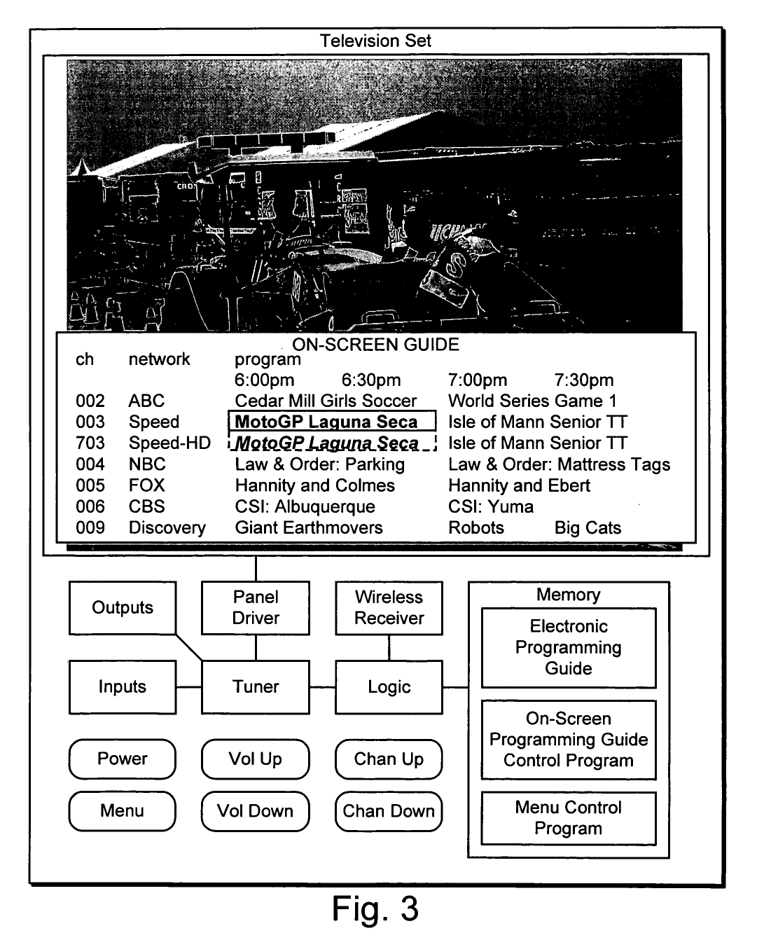

FIG. 3 illustrates the on-screen programming guide as it appears after the user has “arrowed down” to select channel 003. The software has hidden the channel 711 information and, instead, inserted into the on-screen programming guide information for channel 703, which the software has identified as corresponding to channel 003.

Having the HD content automatically displayed in the on-screen programming guide gives the user an improved opportunity to watch the superior HD content, without having to remember to manually search the HD channel block to see if such content is available.

With the HD channel information instantly available on screen, the user can simply select that channel for viewing or recording.

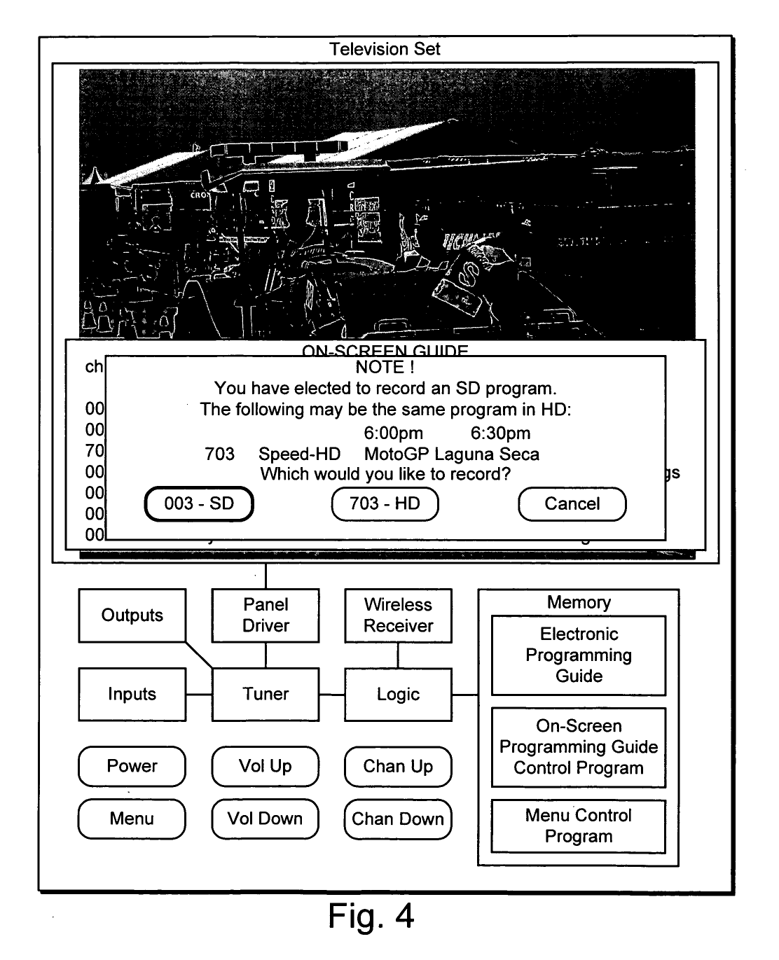

FIG. 4 illustrates an exemplary on-screen dialog box which may, in some embodiments, be used in addition to, or in lieu of, the automatic insertion method described above. If the user pulls up the on-screen programming guide (obscured) and selects an SD program for viewing or recording, the software displays the dialog box (with or without having inserted the HD channel into the on-screen programming guide), alerting the user to the corresponding HD content. The user can then select either the SD or the HD channel.

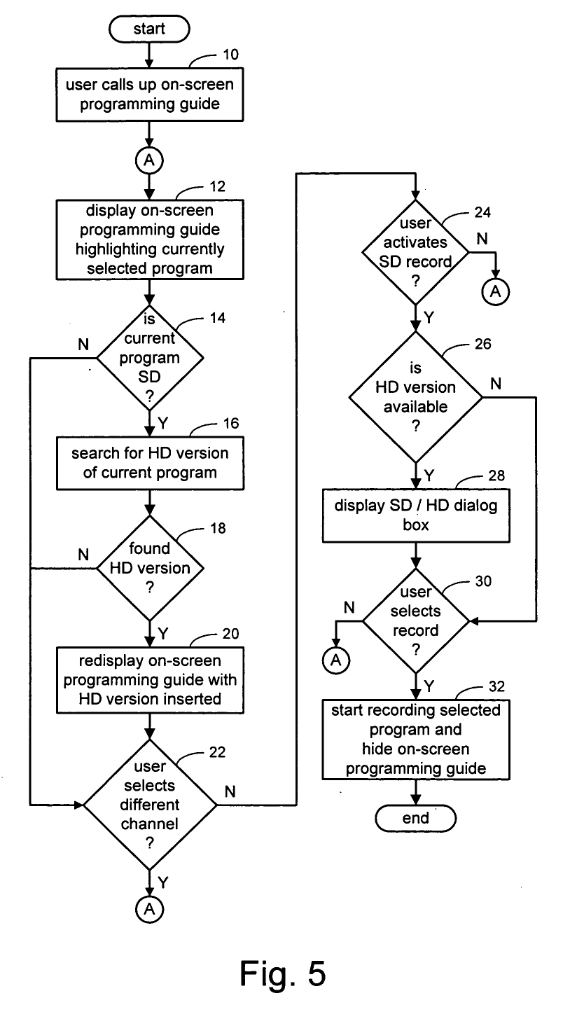

FIG. 5 illustrates one embodiment of a method of operation of the software or hardware of the television set which implements this invention. The method starts when the user calls up (10) the on-screen programming guide, typically by pressing a “Guide” button on the remote control unit. The television set displays (12) the on-screen programming guide, highlighting the program currently being viewed. If (14) the current program is in SD, the television set searches (16) for an HD version of this same program on a different channel. If (18) one is found, the television set redisplays (20) the on-screen programming guide with the HD channel information inserted at the correct location. If (22) the user selects a different channel, such as by arrowing or paging up or down in the on-screen programming guide, the television set returns (A) to again display (12) the on-screen programming guide, this time highlighting the currently selected program rather than the currently viewed program.

If (24) the user activates a record for an SD program in the on-screen programming guide, meaning typically that he presses the “Select” button on his remote control unit, and if (26) the television set has determined that an HD version is available, the television set displays (28) the SD/HD selection dialog box. If (30) the user selects one of the channels for viewing or recording (rather than selecting “Cancel”), the television set starts (32) displaying or recording the selected program, and hides the on-screen programming guide.

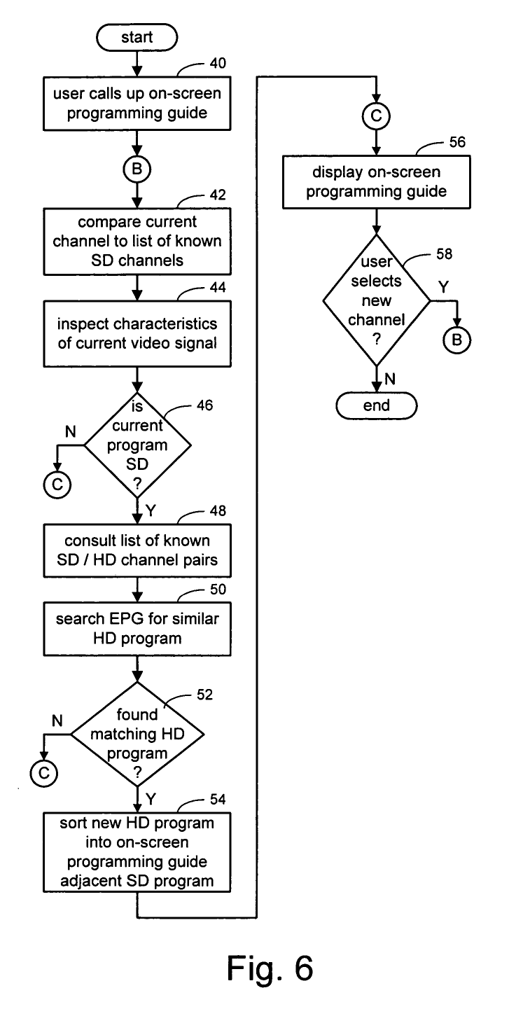

FIG. 6 illustrates one embodiment of a method of operation of the software or hardware of the television set which implements the process of selecting an HD channel to display in conjunction with a selected SD channel.

The method begins after the user calls up (40) the on-screen programming guide. First, the software determines whether the current channel is an SD channel, and thus whether an HD counterpart should be searched for. The software may do this by comparing (42) the current channel number to a list of known SD channels, and/or it may do this by inspecting (44) electrical or data characteristics of the current video signal. If (46) the channel is identified as an SD channel, the software then attempts to identify an HD counterpart to the current SD program. It may do this by consulting (48) a list of known SD/HD channel pairs, and/or it may search (50) through the EPG for a similar program. In some embodiments, it may search by the title of the program; the SD program and the HD program will typically have identical or at least very similar titles, differing often only by the addition of “in HD” or the like to the title of the HD version. In other embodiments, it may search through other EPG data such as the brief “info” description that accompanies most programs.

If (52) a matching HD program is found, or is believed to be found, the software sorts (54) that channel's EPG data into the on-screen programming guide in the appropriate location, such as immediately following the SD channel's row, and displays (56) the on-screen programming guide on the display panel. The on-screen programming guide may be displayed as an overlay, or with the current program in a picture-in-picture (PIP), or what have you. In some embodiments, in which the television set has two or more tuners and there is at least one tuner not in use, the television may set that unused tuner to the HD program, and display both the SD program and the HD program in a respective PIP window, enabling the user to visually confirm that the HD program does, in fact, correspond to the selected SD program.

If (58) the user selects a different SD program, the software returns (B) to hunting for an HD counterpart for that newly selected channel, and proceeds as detailed above.

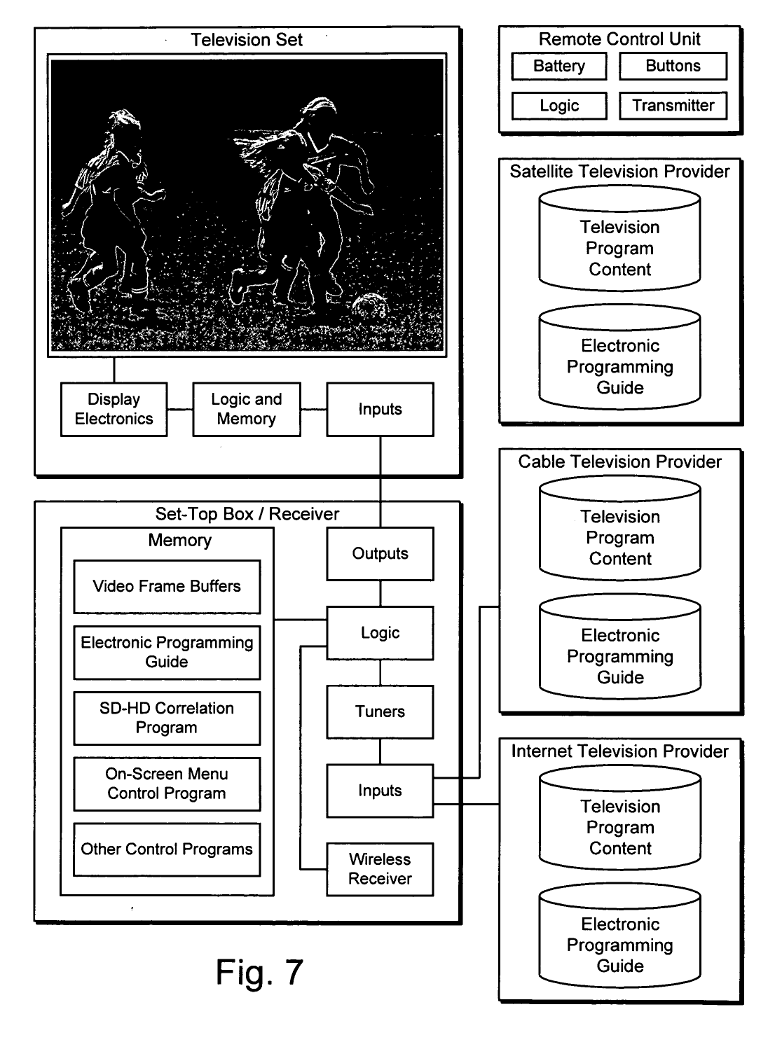

FIG. 7. illustrates one embodiment of a television system implementing this invention. The invention is implemented, in this instance, as an SD-HD Correlation Program residing in memory (or storage) of a set-top box or receiver component. The set-top box component is separate from the television set. The television set includes a display panel (shown as displaying a scene from a girls soccer game), display electronics for driving the panel, logic and memory for controlling operation of the television set, and one or more inputs for receiving video signals.

The set-top box includes one or more outputs, one of which is connected to an input of the television set to provide a video signal to the television set. The set-top box includes one or more inputs for receiving video signals from external sources, one or more tuners for extracting video content from the incoming signals, and logic for controlling operation of the set-top box and for performing various fixed and programmable functions. The set-top box includes memory for storing video frame buffers, electronic programming guide data, an on-screen menu control program, and other control programs, as well as the SD-HD Correlation Program which identifies HD programs or channels which may correspond to SD programs or channels.

The television system also includes a remote control unit via which a user may send control signals to a wireless receiver of the set-top box. The remote control unit includes a plurality of buttons, a wireless transmitter, logic, and a battery.

The television system can be connected to receive video programs and/or electronic programming guide data from any of a variety of external sources. Three sources are shown: a satellite television provider, a cable television provider, and an internet television provider. It is not necessary that any particular source provides both television program content and electronic program guide data.

In some embodiments, the set-top box is able to correlate, for example, an HD program being broadcast by the cable television provider and an SD program being broadcast by the satellite television provider, and present the user the option of viewing or recording the HD program even though the user had originally selected the SD program. The On-Screen Menu Control Program may, in some such implementations, be able to insert e.g. an entry from the cable television EPG into an on-screen programming guide prepared primarily from the satellite EPG data. In other words, the set-top box can intermix data from the two separate EPGs to present one on-screen programming guide.

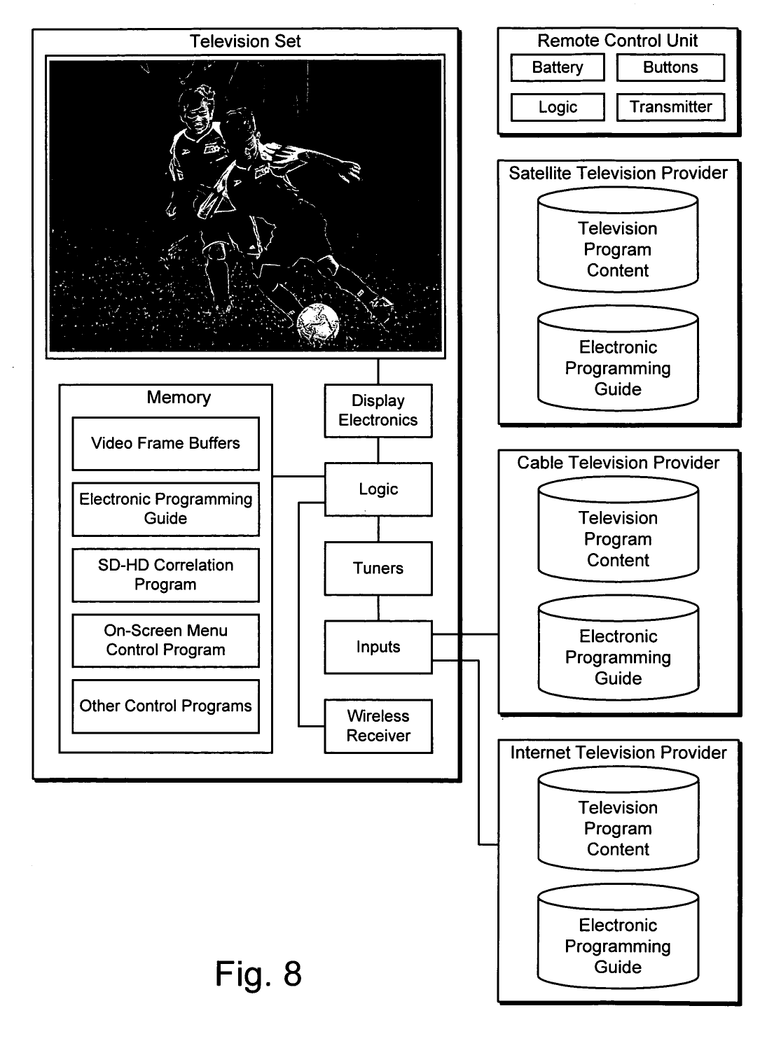

FIG. 8 illustrates another embodiment in which the television set itself embodies both the display panel technologies and the EPG technologies. Whereas in FIG. 7 the set-top box is the on-screen programming guide display apparatus which performs the HD-SD program/channel correlation, in FIG. 8, the television set itself is the on-screen programming guide display apparatus. The television set includes the display electronics, logic, tuners, wireless receiver for the remote, and; in its memory, the video frame buffers, EPG data, SD-HD Correlation Program, On-Screen Menu Control Program, and other control programs. The television includes inputs for interfacing with the various external video and EPG sources.

### CONCLUSION

When one component is said to be adjacent to or coupled to another component, it should not be interpreted to mean that there is absolutely nothing between the two components, only that they are in the order indicated and are connected somehow.

The various features illustrated in the figures may be combined in many ways, and should not be interpreted as though limited to the specific embodiments in which they were explained and shown.

While various functionalities of the present invention have been referred to as being performed by “the software”, the reader should understand that these functionalities may, in most cases, be equally well performed by hardware, whether programmable or hard-wired.

While the invention has been described with reference to embodiments which “shuffle in” the HD channel EPG data corresponding to a currently-viewed SD channel, the invention may equally well be practiced in other manners, such as by shuffling, for two or more or perhaps even all of the SD channels whose EPG data is displayed in the on-screen programming guide, all available corresponding HD channel EPG data.

The EPG data will, in some instances, be retrieved from the same source as the television programs themselves, such as the cable or satellite system or terrestrial broadcast. The EPG data may, in other instances, be retrieved from other source(s), such as one or more internet sites, dialup services, or what have you.

The terms “SD” and “HD” should not be interpreted to be limited to any particular resolutions such as those commonly available in the United States of America on the filing date of this application. Rather, the invention may be practiced in connection with any programming which is broadcast in two or more resolution levels, compression levels, color depths, or what have you.

And it should be noted that some television sets are coupled to two or more sources. For example, the television set may be coupled to receive content via cable, satellite, terrestrial broadcast, and internet simultaneously. The invention may be practiced in embodiments in which, for example, the SD program arrives via a coaxial cable system and the HD broadcast arrives via a fiber optic internet connection.

And it should be noted that the invention may seek out not only an alternate program having a higher actual resolution (pixel count), but it may (also or alternatively) seek out an alternate program which has a lower compression ratio regardless of resolution. In some instances, it may be more desirable to watch e.g. an SD program broadcast with no video compression, than an HD program which has been compressed so heavily as to be rendered severely “artifacty”. In this case, the former may be regarded, for purposes of this invention, as the “HD program” and the latter as the “SD program”.

And while the invention has been described with reference to a television set which implements it, the reader should understand that the invention can readily be practiced in a variety of related components, such as a cable television “set top box”, or a satellite television receiver, or what have you. Regardless of whether the functionality is embedded directly within the television itself, or within a component which is external to and coupled to the television set, the device which performs the invention may be referred to as an on-screen programming guide display apparatus.

The term “display panel” is intended to mean any sort of video display apparatus, such as cathode ray tubes, liquid crystal displays, plasma displays, projectors, and so forth. It is not intended to be limited to those commonly referred to as “flat panels”.

Finally, and somewhat less advantageously, the invention may be practiced in an embodiment in which the “simulcast” requirements are somewhat relaxed. For example, the television set could find the same program in HD at a later time slot, and ask the user “would you rather watch the SD version now, or the HD version in 30 minutes?”

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. A method of operating a television set in response to control inputs from a user, the method comprising:
receiving from the user a request to select an SD program on a first channel;
in response to the request, identifying an HD version of the SD program on a second channel; and
providing to the user an on-screen visual prompt informing the user of the HD version;
whereby the user is enabled to select the HD version instead of the SD version.

2. The method of claim 1 wherein providing the prompt comprises:
sorting the HD version into an on-screen programming guide page displayed to include the SD program, regardless of whether the second channel would by virtue of its channel number have appeared on the same on-screen programming guide page as the first channel.

3. The method of claim 1 wherein providing the prompt comprises:
displaying a dialog box from which the user can select either the SD program or the HD program.

4. The method of claim 1 wherein:
the receiving of the request and the identifying of the HD version are performed by a tuner component which is coupled to receive the first and second channels from a video source via a communication link, and which is coupled to the television set via a video signal link.

5. The method of claim 4 wherein:
the communication link comprises a cable television system.

6. The method of claim 4 wherein:
the communication link comprises a satellite television system.

7. The method of claim 4 wherein:
the communication link comprises the internet.

8. The method of claim 1 wherein:
the receiving of the request, the identifying of the HD version, and the providing of the on-screen visual prompt are performed by the television set.

9. The method of claim 1 wherein:
the SD program and the HD version are received via different communication links.

10. A method whereby an on-screen programming guide display apparatus causes data from an electronic programming guide to be presented at a display panel, the method comprising:
receiving a user request to display an on-screen programming guide;
identifying an SD channel whose electronic programming guide data are to be included in the on-screen programming guide displayed;
identifying an HD channel including a program corresponding to a program broadcast on the identified SD channel; and
including the identified HD channel's electronic programming guide data in the on-screen programming guide to be displayed; and
displaying the on-screen programming guide including the identified HD channel's electronic programming guide data.

11. The method of claim 10 further comprising:
sorting the identified HD channel's electronic programming guide data into the displayed on-screen programming guide adjacent an entry for the identified SD channel.

12. The method of claim 11 wherein:
the identified HD channel's electronic programming guide data is inserted immediately below the entry for the identified SD channel.

13. The method of claim 10 further comprising:
displaying a dialog box giving the user a choice of selecting the SD channel or the HD channel.

14. The method of claim 10 further comprising:
displaying video from the SD channel in a first PIP window; and
displaying video from the HD channel in a second PIP window;
whereby the user is enabled to visually confirm that the HD channel corresponds to the SD channel.

15. An on-screen programming guide display apparatus comprising:
means for receiving an electronic program guide;
means for receiving a user-initiated request to display an on-screen programming guide;
means for determining whether a first channel contains SD content;
means, responsive to the means for determining, for identifying a second channel contains HD content possibly corresponding to the SD content of the first channel;
means for preparing the on-screen programming guide from the electronic program guide; and
means, responsive to the means for identifying, for inserting electronic program guide data regarding the second channel into the prepared on-screen programming guide;
whereby on-screen programming guide data for the second channel is displayed in conjunction with on-screen programming guide data for the first channel, regardless of respective channel numbers of the first and second channels.

16. The on-screen programming guide display apparatus of claim 15 wherein the means for inserting comprises:
means for placing the on-screen programming guide data for the second channel adjacent the on-screen programming guide data for the first channel.

17. The on-screen programming guide display apparatus of claim 16 wherein the means for placing comprises:
means for removing the on-screen programming guide data for the second channel in response to the user selecting a channel other than the first channel.

18. The on-screen programming guide display apparatus of claim 15 further comprising:
means, responsive to the user selecting the first channel for viewing or recording, for causing display of a dialog box giving the user an opportunity to select either the first channel or the second channel for such viewing or recording.

19. The on-screen programming guide display apparatus of claim 15 further comprising:
a display panel coupled to display the on-screen programming guide.

20. The on-screen programming guide display apparatus of claim 15 configured as a television set.

21. The on-screen programming guide display apparatus of claim 15 configured as a set-top box.

22. The on-screen programming guide display apparatus of claim 15 configured as a digital video recorder.

23. The on-screen programming guide display apparatus of claim 15 configured as a receiver.

24. A television set comprising:
an input for receiving a video input signal having a plurality of channels including a plurality of SD channels broadcasting SD programs and at least one HD channel broadcasting an HD program;
a display panel for displaying video images;
panel driver electronics coupled to the display panel for providing to the display panel a video output signal;
a logic device for performing control operations of the television set;
memory coupled to the logic device and capable of storing data for use in the control operations, the data including an electronic programming guide; and
on-screen programming guide control means for determining that the HD program corresponds to one of the SD programs, for generating an on-screen programming guide for display on the display panel, and for including, in the on-screen programming guide, electronic program guide data for the HD program with electronic program guide data for the corresponding SD program.

25. The television set of claim 24 wherein:
the on-screen programming guide control means comprises software stored in the memory for execution by the logic device.

26. The television set of claim 25 wherein:
the on-screen programming guide control means is further adapted for placing the electronic program guide data for the HD program adjacent the electronic program guide data for the corresponding SD program.

27. The television set of claim 24 wherein:
the on-screen programming guide control means is further adapted for removing from the displayed on-screen programming guide the electronic program guide data for the HD program in response to a user deselecting the corresponding SD program.

28. The television set of claim 24 wherein:
the on-screen programming guide control means is further adapted for removing from the displayed on-screen programming guide the electronic program guide data for the HD program in response to the electronic program guide data for the corresponding SD program not being included in the displayed on-screen programming guide.

29. A method of displaying an on-screen programming guide on a display panel, the method comprising:
including, in the on-screen programming guide, electronic programming guide data for a plurality of SD channels having channel numbers in a range;
for one of the SD channels whose electronic programming guide data is included in the on-screen programming guide, identifying a corresponding HD channel having a channel number outside the range; and
also including, in the on-screen programming guide, electronic programming guide data for the corresponding HD channel.

30. The method of claim 29 wherein the also including comprises:
placing the electronic programming guide data for the corresponding HD channel adjacent the electronic programming guide data of its corresponding one of the SD channels.

31. The method of claim 29 further comprising:
in response to the one SD channel being highlighted in the on-screen programming guide for selection by a user, also highlighting the corresponding HD channel.
